(19) United States
(12) Patent Application Publication
(10) Pub. No.: US 2014/0108057 A1
(43) Pub. Date: Apr. 17, 2014

(54) INSURANCE INSTRUMENT, INSURANCE COVERAGE, AND METHOD OF USE THEREOF

(71) Applicants: Kip Robert Daniels, Naperville, IL (US); Worth Thomas Blackwell, St. Petersburg, FL (US)

(72) Inventors: Kip Robert Daniels, Naperville, IL (US); Worth Thomas Blackwell, St. Petersburg, FL (US)

(21) Appl. No.: 13/939,047

(22) Filed: Jul. 10, 2013

Related U.S. Application Data
(60) Provisional application No. 61/714,986, filed on Oct. 17, 2012.

(51) Int. Cl. G06Q 40/08

(52) U.S. Cl. CPC G06Q 40/08
USPC 705/4

(57) ABSTRACT

A new type of insurance instrument, insurance coverage, or method of offering insurance instruments and coverage to facilitate bodily injury settlements by creating a product designed to protect the interests of primary and secondary payers of future medical costs linked with bodily injury claims.

### CROSS-REFERENCE TO RELATED APPLICATION

The present non provisional utility patent application claims priority from and the benefit of U.S. Provisional Patent Application No. 61/714,986, filed Oct. 17, 2012, entitled INSURANCE INSTRUMENT, INSURANCE COVERAGE, AND METHOD OF USE THEREOF, which is hereby incorporated herein fully by reference.

### FIELD OF THE INVENTION

The present invention relates to a new type of insurance instrument, insurance coverage, or method of offering insurance instruments and coverage to facilitate bodily injury settlements by creating a product designed to protect the interests of primary and secondary payers of future medical costs linked with bodily injury claims.

### BACKGROUND

Unlike in many countries where medical care is socialized and costs are often covered by a government, in the United States most of the costs associated with medical care are paid directly or indirectly by patients and their insurance. Coverage is obtained mostly through self-purchased or employer-purchased insurance products of many types. In some cases, where a person is indigent, old, or sick, there exists in the United States a limited level of governmental coverage giving some citizens socialized medicine. The interface between these two treatments creates unique problems requiring unique solutions, and this invention resolves one of these unique problems.

As a result of this pay-per-use medical care system, when present or future medical care is caused directly or indirectly by the actions of a third party, such as resulting from third-party negligent injuries or work-related injuries, the cost must be borne by the third party and not ultimately end up borne by the government. In the United States, much of the transfer mechanism of medical costs between individuals and parties relies in one way or another on the judicial system. Injured parties hire lawyers and sue or threaten to sue these third parties in order to get the cost of medical care transferred to third parties and their insurance providers. As part of the lawsuit/claim settlement process, a portion of the amount is generally set aside for past, present and future medical care. While past medical care costs are easy to quantify and present costs are also known, future medical costs are often elusive. Some injured parties may want to “hope for the best” and try to settle, ignoring the potential future costs.

In cases where the injured party one day becomes or qualifies as a recipient of governmental sponsored medical care, the government may be left to pay for care on behalf of the true culpable party, who may have settled the claim. Interested parties to bodily injury claims may be held accountable by both federal and state government agencies if a claim does not address or identify potential future medical needs, resulting in penalties, litigation and a suspension of health benefits for an injured party. These compliance issues have the ability to affect any judgment or settlement in which a third party has liability or potential liability and/or an injured party was provided medical treatment, or has potential future need for medical treatment related to the alleged injury.

For example, injured party A incurs $30,000 of medical costs at the time of an injury, for example damage to a kidney. The party has two kidneys and does not immediately need expensive dialysis care. Party A does not really understands that he/she is 50% likely to be faced with costs of $10,000+ for each subsequent year if the second kidney stops working. Party A may bring an action against a guilty party and settle for a sum of $100,000, covering immediate medical costs. In this example, if party A ever becomes eligible for governmental medical care, the government is 50% likely to be left with a cost of $10,000/year that the party may not be able to pay and was ultimately caused by the guilty party.

Under U.S. law, because penalties and liabilities can attach to both injured parties and defendants if obligations to the government are not satisfied, it is important to analyze the injured party's medical treatment to determine if there is need of potential future medical treatment related to a claim, and its judgment or settlement. Accordingly, there is a need by all interested parties to efficiently evaluate, forecast and fund future medical needs through a cos-t effective and compliant process with federal and state laws.

Currently in claims for “workers' compensation,” general liability or any other type of insurance claim resulting from bodily injury, a major obstacle to resolving the claim is the determination of/or proper identification of present and future medical expenses as part of any settlement with the injured party. Anticipating future medical care is difficult and often exceeds pessimistic assumptions. Because of the high cost associated with the health care services, estimates by the negotiating parties may not be sufficient to cover actual costs and this will not facilitate adequately funded settlements.

In the above example, a potential hidden cost of $10,000/year borne by a 25-year-old with compound interest may in fact mandate the provision of up to $1,000,000 in anticipated medical costs. In this example, a settlement of $100,000 would be insufficient and would result in the injured party being unable to cover future medical costs and the government's paying for the dialysis. The anticipation of future medical costs would require the same settlement to be north of $1,000,000, creating a barrier to settlement and a strong motivation for the defendant to litigate the claim. For example, the injured party and insurance entity may desire to settle a claim for a small lump sum, often identifying few to no potential future medical costs, creating a possible gap in funding for related treatment in the future, thus creating federal and/or state cause of action exposures to all interested parties.

Federal and State Governments' Interest/Standing in Settlements

Congress has enacted several statutes and regulations providing medical care benefits to those who might not otherwise be able to obtain them. In providing these benefits, Congress has also empowered various governmental agencies to pursue recoupment of these benefits through liens and subrogation rights when the need for medical benefits is caused by a third party (“third party tortfeasor”) who is legally or potentially liable for the medical care related to the injured party's alleged injury or condition and wishes to be released from further or future medical liabilities through payment (Settlement/Judgment/Award).

While the United States has no nationalized health system, there is a social system affording certain segments of the citizenry access to health care. Two different governmental-run programs share the burden for certain segments of the population. The first is called “Medicaid.” Medicaid is a health program for certain people and families with low incomes and resources. It is a means-tested program jointly funded by the states and federal government, and it is generally managed by the states. Medicaid is the largest source of funding for medical and health-related services for people with limited income in the United States. Medicaid under the statute enjoys the same rights as Medicare with regard to reimbursement and future consideration.

Medicare, not to be confused with Medicaid, is a national social insurance program, administered by the U.S. federal government established in 1965 as subchapter XVII of the Social Security Act. Congress divided Medicare into one definitional part, part C, and three substantive parts, Parts A, B and D. Part A provides primary hospital insurance benefits. Part B provides supplementary medical insurance for physicians' fees and other services outside a hospital setting. Part D was created as part of the Medicare Modernization Act (MMA) of 2003 and provides recipients with prescription drug benefits that were unavailable before its enactment. The Medicare program's intent is to provide the same type of health care as could be obtained by a comprehensive insurance plan offered by private health care insurers. The specific purpose of the program is to provide a coordinated and comprehensive approach to federal health insurance and medical care coverage for the aged and disabled.

In 2010, Medicare provided health insurance to 48 million Americans—40 million people age 65 and older and eight million younger people with disabilities. Medicare serves a large population of old, sick and low-income people. On average, Medicare covers about half (48 percent) of health care costs for enrollees. Overtime, the coverage of these two programs seems to be increasing and not decreasing, so the importance of these programs cannot be challenged.

Recovery Rights of the United States

When a person receives medical benefits under either Part A, Part B or Part D, the federal government is subrogated to any right a Medicare recipient has to payment for such item or service under a group health plan, workers compensation law, plan of the United States or a state, an automobile policy, a liability policy or plan (including a self-insured plan), or no-fault insurance.

Payment of either a settlement or judgment to a Medicare recipient or non-Medicare-eligible plaintiff is characterized as a “third-party payment.” Upon learning that Medicare paid a claim for which the third-party payer has or should have paid, the third-party payer must provide notice to Medicare. The Medicare recipient must reimburse Medicare within sixty (60) days if he/she receives a third-party payment. If the beneficiary fails to reimburse Medicare, the party who made the payment to the recipient is liable for the reimbursement of Medicare even though it has already paid the recipient or other party. Federal statute also provides for a monetary penalty against those who fail to satisfy a Medicare lien. In addition, a cause of action exists for the federal government to recover double the amount of paid Medicare benefits from entities which include, but not limited to, liability insurance companies, self-insured plans, and the Medicare beneficiary. Thus, it is important to discover whether Medicare has paid any benefits early in a claim or lawsuit.

Adequate Consideration of Medicare/Medicaid Programs in Settlement/Judgment or Award Proceedings

Congress enacted, as part of the 1980 Omnibus Reconciliation Act, provisions to establish the Medicare/Medicaid and later the State Children's Health Insurance Programs as “secondary payers” when a primary payer exists. Primary Payers are considered liability or Non-Group Healthcare Plans (NGHPs) which include a Workers' Compensation plan, Employee Retirement Income Security Act (ERISA) plan, plans of the United States or a state, an automobile policy, a liability policy or plan (including self-insured plans), or no-fault insurance.

Medicare/Medicaid takes the position of a secondary payer in cases where there is another culpable party, such as an insured, self-insurer and/or its insurance carrier as set forth in the Medicare Secondary Payer Act (MSPA) 42 U.S.C. §1395y and 42 C.F.R. §411:1, et al. In July of 2001, the Centers for Medicare and Medicaid Services (CMS) promulgated a memorandum describing, in detail, the government's preferred method of consideration of its interest when settling a claim with a Medicare or potential Medicare recipient; this CMS policy memorandum (The Patel Memo) described what is commonly known as a Set-Aside or Medicare Set-Aside (MSA).

The Set-Aside or MSA is a future medical cost projection identifying Medicare covered and non-covered medical treatment that can reasonably be assumed to be needed over the life expectancy of an injured party. The purpose of the Set-Aside or MSA is to provide funds to the injured party to pay for future medical expenses that would otherwise be covered by Medicare, also known as “qualified medical expenses.” If the injured party incurs qualified medical expenses exhausting the anticipated annual amount (if the funding is structured using an annuity) or totally exhausts the account short of the injured party's anticipated life expectancy, then Medicare will assume the “primary payer” position paying for any excess expenses until the next annual payment is made to the account or for rest of the injured party's remaining life. Settlements meeting certain criteria should also submit the future medical cost projection to the CMS or its Review Center Contractor for a determination process where the sufficiency of the set-aside amount is tested. By establishing a Set-Aside Account, parties to a settlement are protecting Medicare's interest and complying with the MSPA. This process protects all interested parties from exposure to future statutory rights of recovery or causes of action by the federal government and its agencies.

CMS Workers Compensation Review Thresholds

Claims in which an injured party is Medicare-eligible at the time of settlement, and the total settlement value is $25,000 or greater, if there is a “reasonable expectation” that the injured party will be Medicare-eligible within thirty (30) months of settlement, and the total settlement value exceeds $250,000 are conditions CMS feels support their contention that primary payers voluntarily submit a set-aside in Workers' Compensation claims for review and a determination of sufficiency.

It is clear in certain claims, the insurance carriers or insured have an affirmative duty (exposure) to Medicare/Medicaid after the case is settled. Since many injured parties can end up needing Medicare/Medicaid programs if at a reasonable time in the future they are unable to pay for their medical expenses. These governmental programs have a strong and legitimate interest in the distribution and administration of settlements' funding as they are entered. “Medicare compliance” is the general term used to describe the complex compliance issues surrounding bodily injury claims and their resolution process. A Medicare compliance program refers to an entitys' effort to adhere to federal regulations pertaining to the Medicare Secondary Payer (MSP) Statute, Center for Medicare & Medicaid Services Administrative rules and fiat, and the Medicare, Medicaid & SCHIP Extension Act (MMSEA).

When settlements are negotiated directly between the injured party and the defense as shown at FIG. 1, a lump-sum dollar amount 6 also known as an injury settlement may be given 8 to the injured party 2 to cover among other things, current and anticipated medical costs 9 given by a medical provider 10. In FIG. 1, the injured party 2 may rely on an attorney 4 to help negotiate and secure the settlement 6 from the defendant 3 ultimately paying 7 the settlement. The defendant 3 also often relies on an attorney 5 and provides guidance 12 by talking directly with the injured party's attorney 11.

Many injured parties given sums for future medical care have few resources and spend these sums on non-related medical treatment or non-covered matters. Federal legislation makes the “responsible” party (in FIG. 1 the defendant 3) or “Primary Payer” obligated to reimburse Medicare for expenses (conditional payments) incurred by the Medicare program if providing the recipient claimant/plaintiff 2 treatment related to or covered by an insurance claim or policy. Medicare's right to reimbursement accrues only once the “responsible” party/primary payer pays a settlement or award on the claim. But in certain instances, non complaint settlements may leave all interested parties exposed to post-settlement accrual of lien amounts from Medicare/Medicaid if the program is not made aware of the settlement and continues to pay for claim-related treatment.

FIG. 2 shows a case 100 where the defendant 3 is covered by an insurer 20 who will pay 21 part or all of the settlement 6 to the injured party 2. As shown, the government 22 such as Medicare and/or Medicaid may ultimately end up paying 23 for medical care 10 when an injured party 2 is unable to afford the care and/or the settlement 6 as paid by the insurer 20 is insufficient or does not plan for these payments. If Medicare knows a specific injury will result in $1,000,000 in future medical expenses and the settlement allocates only a fraction of this cost for future medical costs, the Primary Payer (employer 3 or insurance plan 20 in FIG. 2) may be responsible for the difference 23. Responsibility as a Primary Payer is established not by liability, but simply through any payment by the accused tortfeasor to the injured party. In the case of settlement, Medicare's threat of post-settlement involvement (by seeking reimbursement) may actually have the effect of impeding settlement.

Failure to create a sufficient MSA has its own implications for the “responsible” party. If Medicare concludes the MSA is insufficient, Medicare may not pay for future treatment expenses, or Medicare may pursue an action against the parties for failure to consider Medicare's interests. The future medical costs forecasted by the plan as part of a settlement to compromise a non eligible plaintiff or Medicare beneficiary's injury claim must bear a reasonable relationship to the amount potentially required by the injured party after considering the medical condition, potential exacerbations, current and future Medicare eligibility, and financial instruments meant to pay over time.

Federal and state statutes provide remedy when a Primary Payer uses “superior knowledge” and settles a claim with foreknowledge the injured party will not have sufficient funding for future medical care, that the plaintiff will be damaged by this, is unable (due to cognition or disability) to responsibly administer the identified funds, or the settlement represents a purposeful attempt to shift the burden for future medical expenses to the federal or state government. In the above example, an insurance carrier may have data and statistical evidence that dialysis is costly and likely to happen and in an effort to promote settlement, may not disclose the information to the plaintiff.

Litigation under the MSPA or the Fair Claims Act may be brought against the Primary Payer as either a private cause of action or a federal cause of action. These suits carry penalties of double damages, plus interest or treble damages, plus interest respectively, if successful.

An annual statement of the disbursements must be provided to CMS for review and appropriateness. If expenditures are deemed outside of Medicare's coverage, future Medicare coverage can be terminated. CMS recognizes an MSA on matters governed by the Federal Employees' Compensation Act, the U.S. Longshoremen's and Harbor Workers' Compensation Act and the Federal Coal Mine Health and Safety Act of 1969. CMS currently will review eligibility and provide sufficiency evaluations for settlements of liability cases as workloads permit.

In the event an injured party is Medicare-eligible and has a claim under the Jones Act, a Set-Aside or MSA should be completed to fully protect the interests of all involved parties. Likewise, a Liability Set-Aside is appropriate when settling as a third-party-liability claim, with an underlying claim triggering the MSA thresholds. This also applies to a Federal Employer's Liability Act case with an underlying Longshoreman's action. In some cases, CMS has required an MSA in settlements where Medicare/Social Security Disability eligibility are not in question and the dollar amount for future anticipated medical expenses is large. It is expected that this requirement will affect more liability cases as CMS finalizes policy for liability Set-Asides.

The uncertainty surrounding the potential need for “responsible” parties to create MSAs under the MSP Statute requirements has important implications. Under MSAs, the “responsible” party should ensure all settlement agreements address responsibility for, or the absence of, future Medicare-covered treatment expenses. Insurance entities providing liability coverage in the United States commonly dispute the medical necessity for future medical treatment post-settlement. This issue is complicated by a Federal obligation to consider the Medicare, Medicaid and CHIP programs interest when a settlement seeks to limit or close all future rights to medical coverage under the liability plan. (A liability plan is considered, by the Department of Health and Human Services or DHHS, to be any coverage in which the insurance entity has potential responsibility to provide or reimburse an injured individual for medical expenses incurred as a result of injury, disease or exposure.)

Complying with the rules and meeting obligations created by the MSPA, defendants may be less inclined to settle with plaintiffs and may find themselves in litigation more frequently. For example, a defendant may disagree a bodily injury happened on its premises and if faced with a large out-of-pocket medical cost, may decide to defend the claim instead of settling for an amount that takes into consideration the total medical expense cost. Litigation outcomes are at best uncertain and the costs associated with this process significantly increase claim expenses and, in sufficient numbers, the carrier's financial sustainability.

What is needed is an instrument offered by a third party or insurance entity allowing interested parties to meet all of the mandatory regulatory compliance requirements of the MSPA, help promote cost-effective settlements between injured parties and insurers (Primary Payers) and to protect the parties from any potential legal actions or additional expenses post-settlement related to secondary payers like the Medicare administration.

### SUMMARY

The present invention relates to a new type of insurance instrument called, for example, the Protect Medicare/Medicaid/Medical Insurance (PMI) offered to cover Primary Payers and/or Secondary Payers' risks resulting from settlement of bodily injury claims and other settlements that are associated with deferred medical costs by creating an insurance product that assumes liability and payments up to a policy amount for a fee in case of need of payment. The PMI is designed to prevent allocation and escrow placement of funds and reduce settlement amounts by including the cost of the insurance instrument, thus promoting settlements. The PMI may be offered as many insurance products either as a stand-alone product, using an automated system and software platform, as part of a pre-determined method, etc.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 an illustration of one of the possible processes of settlement of an injury requiring medical care between an injured party and a defendant.

FIG. 2 an illustration of the possible role that a defendant's insurance and/or the government plays in the process of settlement and payment of medical care shown in FIG. 1 according to an embodiment of the present disclosure.

FIG. 3 is an illustration of one potential instance of the insurance company product provider offering a PMI to a defendant insurance to help pay for medical care according to an embodiment of the present disclosure.

FIG. 4 illustrates a potential set of hardware elements that support the use of an electronic online system to offer and/or sell a PMI or other insurance products and/or manage the flow of information between the different parties and/or make payments or control between the different actors illustrated at FIGS. 1-3 according to an embodiment of the present disclosure.

FIG. 5 is a diagrammatic representation of the steps associated with securing CMS approval for settlements between the different parties as shown at FIGS. 1-3 according to an embodiment of the present invention.

FIG. 6 is a schematic representation of a method for generating a Primary Payer insurance provider according to an embodiment of the prior art.

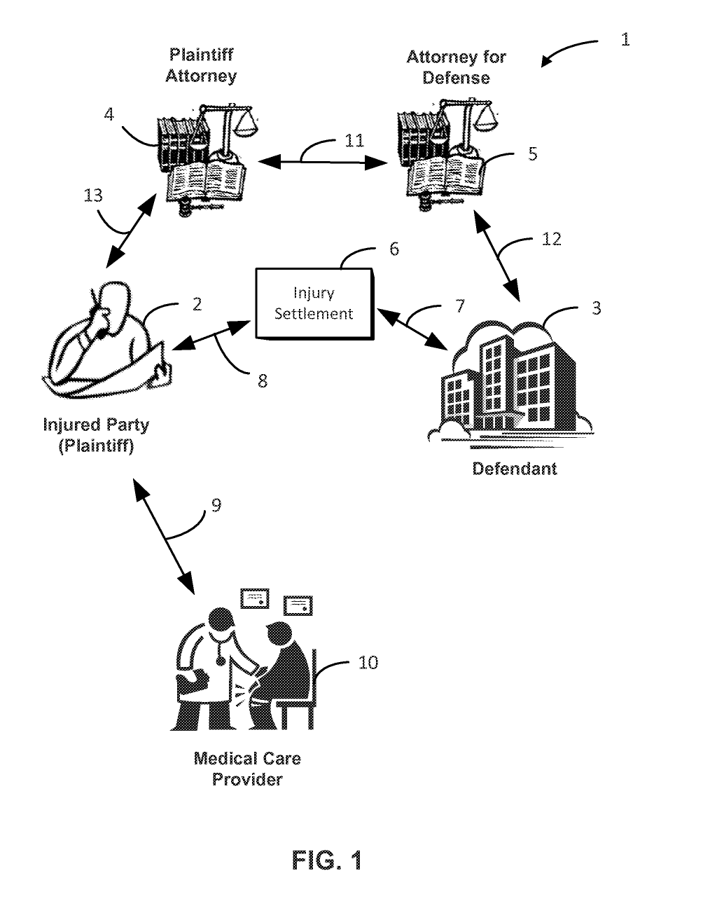

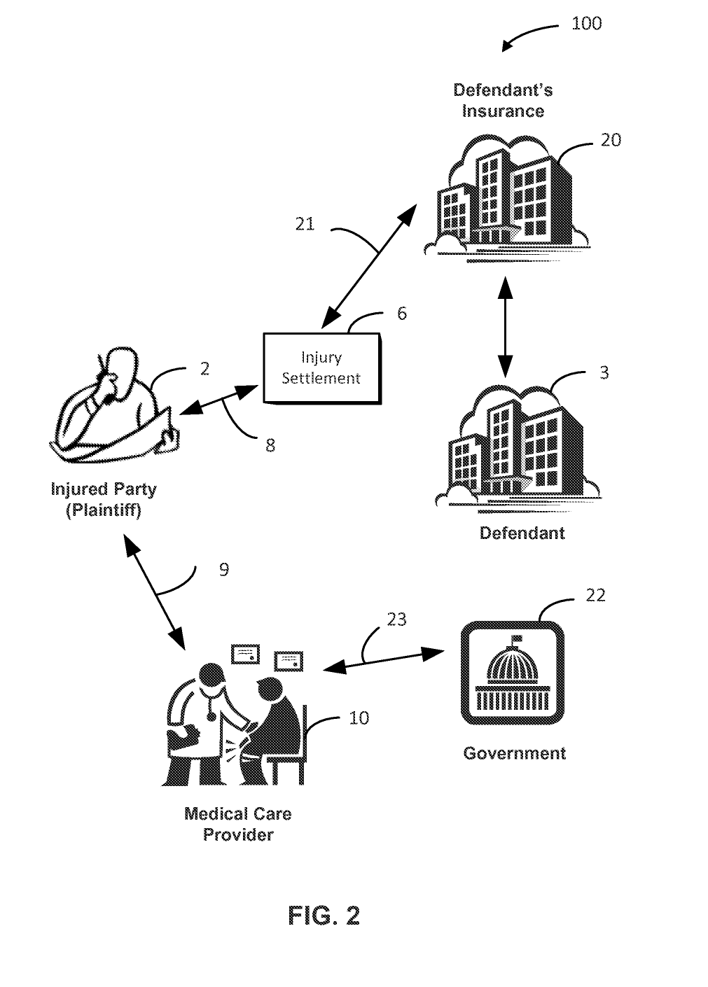

### DETAILED DESCRIPTION

For the purposes of promoting and understanding the principles disclosed herein, reference is now made to the preferred embodiments illustrated in the drawings, and specific language is used to describe the same. It is nevertheless understood no limitation of the scope of the invention is hereby intended. Such alterations and further modifications in the illustrated devices and such further applications of the principles disclosed and illustrated herein are contemplated as would normally occur to one skilled in the art to which this disclosure relates.

Within the scope of this disclosure, what is described is an insurance product designed to help improve the settlement process between two parties described generally as the Plaintiff/Injured Party and the Payee/Defendant. One of ordinary skill in the art will recognize how this insurance product may be adapted to help provide coverage to any relevant and associated relationship where ultimately coverage must be purchased for a third party between two settling parties.

Settlements are often arm's-length negotiations between two parties, often through intermediaries such as attorneys. Some settlements resolve a pending court action, while others may happen before any legal action is undertaken. Generally, settlement negotiations are fluid and the capacity to settle “overnight” helps promote resolutions of conflicts. An injured party or a defendant if forced by law to wait for a long period as settlement amounts are being validated and verified may have remorse or doubts. Generally, any system and process or method of use of any financial instrument or insurance instrument that helps speed up approvals and validation of third party approval will help promote settlements and is needed.

When an insurer or third party desires to enter into a settlement with an injured party, both parties carve out a portion of the settlement as funding to cover the plaintiff's lifetime related medical expenses such as the costs for physical therapy, prescriptions and/or any surgery. The rest of the settlement covers any out-of-pocket medical expenses, attorney fees, pain and suffering and other such costs.

For example, Injured Party A could desire to enter into a settlement with Insurer B for a sum of $750,000 knowing the expected related future medical expenses are $500,000. Such high future medical forecasts are common and potentially impede the settlement process as past medical care, attorney's fees, pain & suffering would be subtracted from the remaining $250,000. Very often, the settling party may find a way to place these sums in a way to prevent the party from accessing these funds. Attorneys' fees are typically a significant percentage (25% to 33%) of the total settlement value. If attorneys' fees were 25% of the total in this example; the injured party would receive $562,000 to cover his/her future medical care, special treatments and reimbursement of past medical treatment. Many settlements financially position injured parties poorly in terms of meeting future medical obligations. Insurers are wary of settlements under the current settlement process because they must fund the entire settlement amount ($750,000). This payment in no way ensures Primary Payer obligations under the MSPA are met; leaving them potentially exposed. In this commonly played out scenario, both parties will bear continuing risks associated with the claim post-settlement, making litigation more likely.

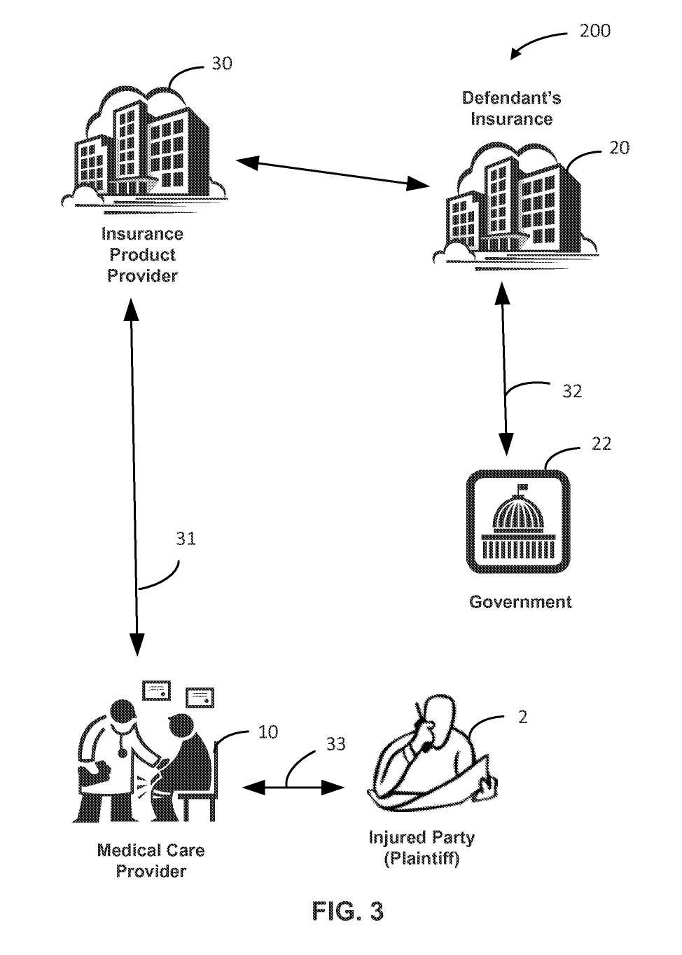

What is contemplated is a new type of insurance instrument, insurance coverage or method of insuring parties allowing a transfer of risk associated with future medical costs post-settlement. As part of this invention, as shown at FIG. 3, a third-party insurance provider 30 offers, for a fee, an insurance coverage/instrument directed at primary insurance entities 20 which have the obligation of fully funding post-settlement long-term treatment 31 to an injured party 2 or litigating the case to effectuate a full release of liability.

In this invention, a third party 30 offers the insurer 20 or the insurance plan a new product, completely changing the dynamics of settlement. The insurer 20 may, for a flat fee purchase an insurance product (or offer it itself) providing post-settlement coverage for payment of related future medical costs of the plaintiff/injured party. The new insurance product/policy will provide coverage, for example, for a specific dollar amount or lifetime medical coverage.

The insurance product will analyze the risk of payment of future medical costs and will associate a current actuarial value for the claim, taking into consideration a fee for the service. This new insurance offering will benefit all interested parties to the claim as premiums for coverage of future medical costs will be significantly less than funding the entire forecasted amount.

For example, an insurance provider may offer settlement insurance for different families and types of injuries, for example back-related injuries, kidney-related injuries, heart injuries, limb damage, etc. These may be adapted based on the life expectancy of the insurance recipient and the current age of the injured party. For example, two attorneys trying to negotiate adequate settlement for a back injury for a 25-year-old injured party may get access to a table of anticipated potential costs, in this example $1,000,000. The two attorneys and their respective insurance providers may then simply index a table of costs offered by the third-party insurance provider of the PMI for back injury. The coverage offered may be, for example, made at a flat fee of $200,000 or more. The coverage offered may also be offered with continuous payments. For a sum of $200,000, the third-party insurance provider will contractually agree to pay medical care provider costs, that would qualify for Medicare/Medicaid up to a fixed amount that would satisfy the MSP and CMS evaluation generally given by the government.

As part of the settlement process, the parties would no longer have to wait for governmental approval, knowing that the insurance is designed using actuarial risk and cost tables to align with the MSP requirements. As with any insurance product, the insurance provider will include all other normally available limitations and restrictions on the policy.

This can have the effect of freeing up large portions of the authorized settlement amount to be used by the parties for other purposes. As an example, if the injured party A and Insurer B scenario above were changed to include the purchase of this insurance instrument covering future (possible) medical expenses of $500,000 at a cost of $20,000, Insurer B could use the $480,000 in funds to “sweeten” the proposed settlement and help bring the settlement to more reasonable conditions.

In the current regime, while certain risks of future costs may be important and only have a very low risk of occurrence, the settling parties who have this risk may be forced by CMS to include these high costs and low probability of occurrence as part of the settlement. For example, a truck driver is in a minor accident and after medical care is given a clean bill of health. The doctor may note a potential neck or back recurring problem in the future that may result in a very serious pain preventing the driver from working in the future.

In this case, if CMS anticipates that back surgery for the driver is likely to result in $200,000 of future costs if associated with an actuarial risk of 10% of occurrence, on the average only $20,000 will be claimed by each policy holder, and thus the cost of the policy to insure the risk will be 10% of the assumed risk, plus, a fair premium, administration costs, and commission may be closer to $20,000 than $200,000 or the risk covered.

At the time of settlement, the insurer will pay a premium for a $200,000 policy releasing the future medical liability of the Primary Payer as long as the volume of the policy is sufficient to remove any liability under the law. At the time of settlement, in the above example, a fee of $20,000 will be tolerable and acceptable to promote settlement where instead, funding a $200,000 medical component to a settlement would not. (i.e., for a minor back injury). This invention will reduce the cost to fund, increase the net proceeds to the injured party and ensure treatment is available when needed; settlements are promoted and greatly facilitated.

Another immediate advantage to insurance entities' using the new insurance product (also applicable as an instrument used by the initial underwriter) is a significant decrease in reserved capital needed to cover anticipated losses. Because settlements are more attractive to Plaintiffs, the insurance entity's claim closure rate will increase, adding capital to the insurance entity's bottom line or reinvestment in the organization by allowing for more coverage to be sold.

The majority of MSAs are submitted for claimants who receive Medicare benefits via disability rather than age. In calendar year 2005, approximately 69% of MSAs were for disabled claimants and the number grew to more than 71% a year later. In 2007, Medicare approved 664+ million dollars in MSAs, which represented 26% of the total settlement between an employee and its insurer. In 2009, Medicare approved $946 million, representing 29% of the total settlements entered between parties.

Over 96% of claimants self-administer their MSAs. Compliance with the MSP based on the data compiled represents approximately 2 billion dollars. The current invention relates to the creation of the “Protect Medicare/Medicaid/Medical Insurance (PMI) Policy” as a system and method for insuring or indemnifying the parties to a bodily injury claim from payments for future medical expenses resulting from (or associated with) a bodily injury claim. The PMI policy system allows another party to accept the risk for assuring funds are available and/or medical costs are paid as treatment occurs post-settlement. This system and method allows for coverage of a specific amount (policy limit) or lifetime medical coverage.

The PMI may be used in at least three specific claim scenarios associated with bodily injury claims and will allow the interested parties to conclude their proposed settlement at a reasonable cost: (1) bodily injury claims in which treatment costs, frequencies and/or durations are not agreed upon by the parties and Medicare's interest is not a factor, (2) bodily injury claims in which future treatment costs are agreed upon by the parties, but Medicare's interest is a factor, and (3) bodily injury claims wherein securing Medicare's approval of the sufficiency of funding for future medical/Medicare costs has resulted in a counterproposal.

In the first scenario above, settling parties may have genuine disagreements as to the different future expectations of medical costs. An injured party may reasonably fear the worst-case scenario and refuse settlement unless the full amount of anticipated medical costs associated with an unlikely event is to be part of the full settlement, while the defendant may refuse to include such large amounts in every settlement. In this first scenario, the injured party and the Defendant can simply agree to include the PMI as part of the settlement, an insurance product designed to cover the future medical out-of-pocket costs.

For example, a driver fears the worst-case scenario where back injury may result in over $200,000 in future medical costs. The parties may agree that a settlement will simply include a PMI capable of covering these possible, but unlikely, costs. In this example, because of the unlikely occurrence of these costs, the PMI may cost only $10,000, thus promoting a very natural settlement between the parties.

In the second scenario above, the governmental interest is a factor and the parties trying to enter a settlement agree generally on the amount of anticipated future medical costs. The parties may agree that with a certain level of certitude, a cost of $500,000 is likely to result from the damage but the amount is too large to allow the party to settle. Using the PMI, the parties are able to lower the amount by purchasing a PMI designed to factor in the risk component. The risk to the defendant above the policy or agreed number may be acceptable third-party risk under the MSA. For example, if the MSA would recommend a provision of anticipated cost of $1,000,000 for an injury, the parties may simply agree that $500,000 in coverage via a fixed PMI is an acceptable risk. Here, the insurance entity or defendant may believe that once a $500,000 PMI is secured for the potential injury, this limits its possible liability to the government to $500,000, an acceptable value.

Finally, in the third scenario described above related to the use of the PMI, the Primary Payer in a bodily injury claim, as a way to protect itself from future liability, may ask for the approval of Medicare/Medicaid of the sufficiency of funding for future medical costs, and as a result, the government responds with a counterproposal. For example, if the parties agree on a potential future medical cost of $200,000, the government may write back with a proposal of $350,000. In that event, to absolve the defendant of any future liability, the PMI purchased for the settlement may be for that amount or greater.

When used, this system and method of transferring payment responsibility for medical and/or Medicare covered treatment related to a bodily injury claim, post-settlement by assigning said risk to another party using an insurance product; the system allows interested parties to measure the financial exposure, injury severity and incorporate the parties' appetite for risk to utilize an insurance product insuring monies dedicated to future medical treatment related to a claim is available to pay providers post-settlement and not accessible or vulnerable to improper disbursements by the injured party or his/her representatives.

The methods making up the steps of establishing the (Protect Medical/Medicare Insurance “PMI” Policy) will maintain compliance with relevant IRS Tax Code provisions; allow insurance entities to release liability for future medical expenses at a discount to present value; lower the monies that insurance entities are statutorily required to have on hand proportional to coverage exposures (Reserves); remove dedicated funds for medical expenses from injured party's custody, mitigating opportunities for improper disbursements; ensure the appropriate and timely reimbursement of providers; allow the insurance entity to create a database of information monitoring injured party treatment frequencies post-settlement.

A defendant may agree to settle hundreds of claims over the same injury and in each settlement has to reserve a large sum for future medical costs to prevent any liability. In theory these costs must be added and reserved as potential claims. The defendant may reason that since the probability of injury on each claimant is low, keeping large reserves for the total sum promised in the settlement is not logical. Under these agreements, a party may have agreed to disburse a sum X when in fact it knows very well only a fraction will be due. This may result in large reserves and a desire to dip into the reserves to approximate actual payments to be owed and not the payments promised in the unlikely event all of the claimants each need the coverage.

Further, in some cases the future medical costs can be placed in an injured party's custody in one way or another either directly or indirectly. This party is then vulnerable to temptation or the desire to pay other debts using the funds. By using a PMI system of insurance, disbursements are controlled and submitted as claims against the insurance until a limit is reached. A medical service provider will also have a better perception of the potential to recover sums when the payer is the insurance entity itself. Finally, the use of a PMI allows for the creation of different databases to help manage payments but also monitor in case of multiple recoveries.

What is contemplated is the development of a robust database to capture and store medical treatment expenditures by injured parties post-settlement, utilize the information to further enhance and revolutionize existing products and develop new products to meet a customer's needs, and share data and information gathered with various groups to assist them in meeting their organizational objectives.

In the above example, the government may have a database where a specific kidney related injury requires the provision of a reserve of a compound $20,000/year of the life of the injured party. A PMI provider who has a database with hundreds of these claims may slowly use the tool to see that care is closer to $30,000/year, but the actual risk of the needed coverage instead being X % is only half of the contemplated amount. The PMI provider may then create its own set of data, help the government revise and actualize estimated amounts or even customize the PMI on other factors and variables such as the location of the patient, etc.

PMI is a product and method for insuring or indemnifying the parties to a bodily injury claim from payments for future medical expenses resulting from (or associated to) a bodily injury claim. The PMI Policy product allows another party to accept the risk for assuring funds are available and/or medical costs are paid as treatment occurs post-settlement. This product and method will allow for coverage of a specific amount (policy limit) or lifetime medical coverage.

The PMI system and method of transferring payment responsibility for medical and/or Medicare covered treatment related to a bodily injury claim is made by assigning said risk to another party using an insurance product; Non-Group Health Plans are Workers' Compensation, General Liability, Malpractice & No-Fault Auto. Each of these micro-segments is a unique market servicing various areas of business in the transfer of risk. All of these lines of insurance have coverage for bodily injury. These can be further divided into more distinct micro-segments as follows:

Insurance Carriers—Workers Compensation

Insurance Carrier—General Liability

Insurance Carriers—No-Fault

Self-Insured Employers

Captive Insurance

Third-Party Administration

State Insurance Funds

Risk Pools and Associations

This is made more complex by a requirement of the Federal Government's current and rigorous enforcement under the Medicare Secondary Payer (MSP) provision to consider the Medicare program's interest in a settlement has a potential to shift the burden of medical costs to the federal government. Under the MSP provisions, all bodily injury claims covered by a Non-Group Health Plan are required to prove a settlement, which releases or limits future liability to pay for causally related treatment for the alleged injury or exposure, is not a purposeful attempt to shift the financial obligation to the Medicare program. It is improper to knowingly enter into a settlement agreement that purposefully shifts the costs of future medical treatment to the Medicare program. Medicare may not recognize any settlement it deems non-complaint and, refuse treatment to the injured beneficiary or require the primary insurance payer to reimburse them for service costs post-settlement. In certain claims it is recommended the parties secure an approval of a settlement's future medical component from the Centers for Medicare/Medicaid Services (CMS).

CMS will, when certain work review thresholds are met, determine whether an amount proposed for future medical expenses by the interested parties is sufficient to reasonably assure that Medicare will not be called upon in the future to make payments for treatments deemed causally related to a bodily injury claim. If the review finds the proposed amount of designated future medical funds to be insufficient, CMS will counter the proposed funding with an amount they deem is sufficient to protect Medicare's financial interests. This is of course a conflict as the Medicare program's financial interest in these cases potentially creates a bias and proclivity to inflate costs in an effort to ensure the program's financial well-being. Statistically, the average submitted future medical proposal to CMS is countered with an amount 33% higher than the original proposal. This unforeseen additional cost many times makes settlement of the bodily injury claim financially unattractive to both the injured party and the defense.

Given the lack of information post-settlement on the use of an individual's future medical needs being utilized on medical treatment related to the said claim, certain underwriter(s) will likely establish the premium on a case-by-case basis at the onset of the products being released to the market. However, in the future either based on the number of policies being written and/or additional post-settlement data being captured, a formulaic or actuarial model will be established to provide the policy in more of a streamlined approach. The different parties will use an app and/or a website page to provide estimated premium on a case and calculate all fees and costs associated with the PMI.

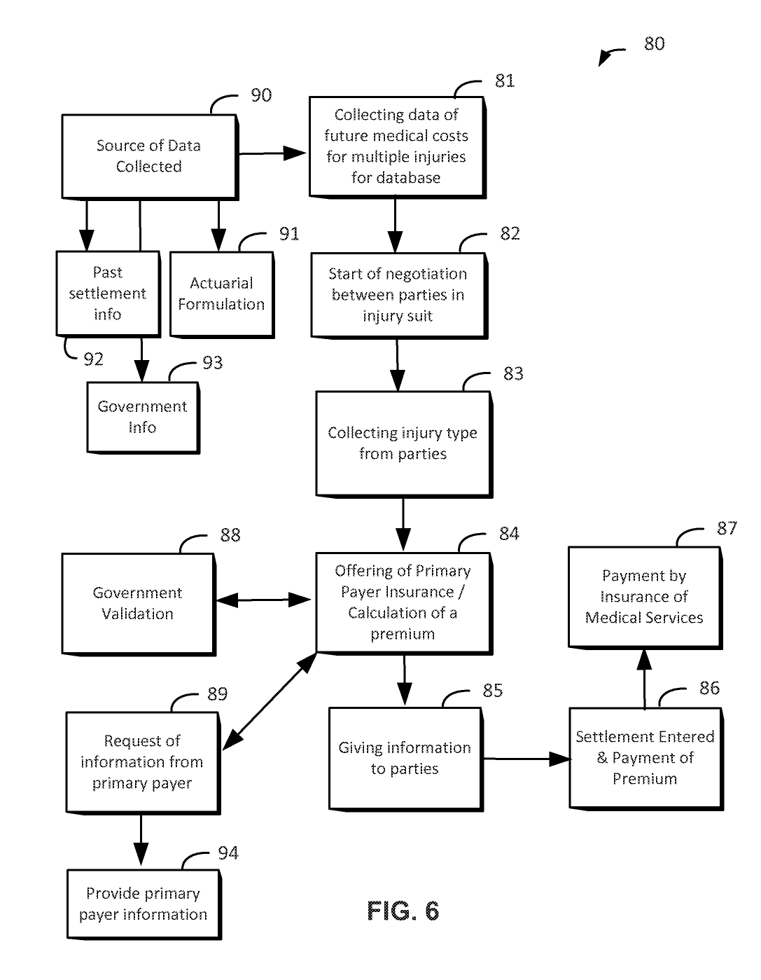

What is contemplated is both a method 80 for generating a primary payer insurance as described above and shown on the diagrams of FIG. 6. FIG. 5 illustrates how from a litigation with medical costs 41, a primary payer must wonder if the government is likely to be a party 42. If the answer is negative, then the parties can simply proceed with settlement 43. In the event the answer is positive or likely to be positive as shown by the arrow, a primary payer can ask and secure approval from Centers for Medicare/Medicaid Services (CMS) 45. The amount is either directly approved 44 or denied 46 and a counter offer is made so the parties may use this new amount and renegotiate 47.

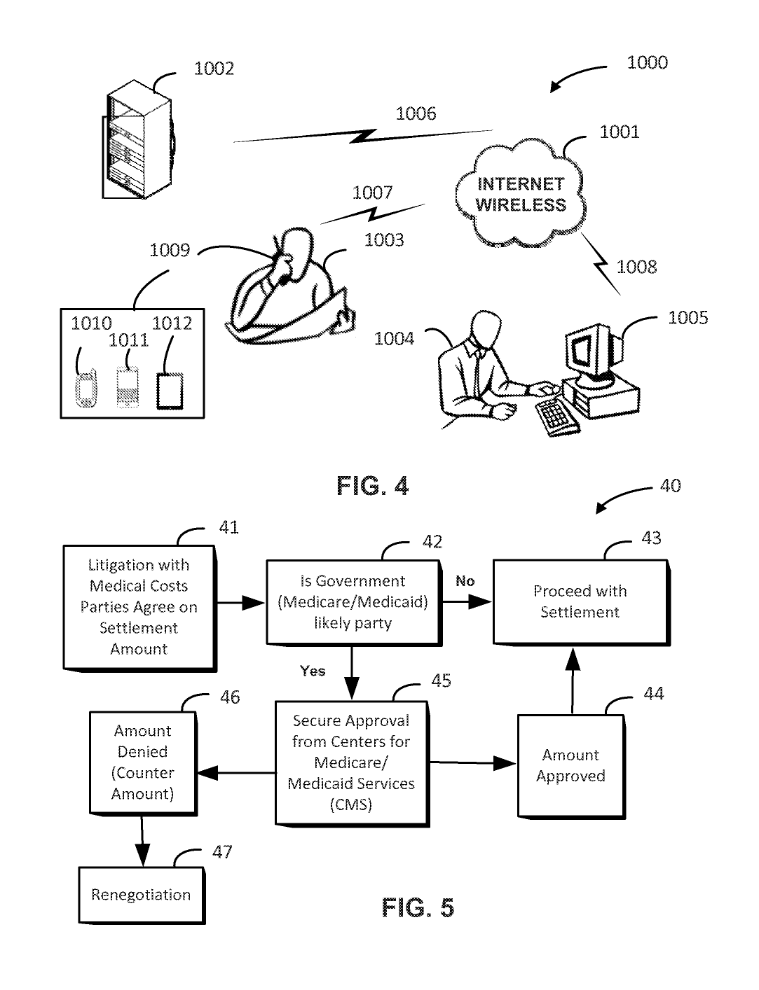

Under the new method 80 of FIG. 6, a system 1000 such as the one shown at FIG. 4 and described below collects in a database located in the memory of a server 1002 as shown data associated with anticipated future medical cost for each of a plurality of injuries 81. For example, back injuries, kidney injuries, or broadly families of injury like car crash injuries, work hand injury, etc. Medical service providers use codes and numbering systems to help identify different families of injuries and associated treatment. What is contemplated is a system that is capable of managing data associated with and related to any type of wrongful and correctable conduct using any one of a plurality of systems current in use.

In the next step, the system and method is designed to allow an injured party and a defendant to enter into a negotiation of a settlement of a personal injury claim between the injured party and the defendant 82. In one case, the settlement associated with one injury suffered by the injured party is part of the plurality of injuries in the database for which data associated with anticipated future medical costs is available.

Next is collecting 83 from the defendant or any other party information on one injury suffered by the injured party for which future medical costs can be anticipated. For example, collecting information that the party suffers from back injury and was in a car accident. Then 84 calculating using the server data relating to the one injury suffered by the injured party a premium to be paid by the Primary Payer for a limit of coverage of the injured party by a Primary Payer insurance to cover the anticipated future medical costs of the injured party linked with the one injury of the injured party. For example, in case of back injury, the system will generate a monthly or a fixed upfront premium associated with covering the risk. For most insurance entities, a premium is determined as the current-day value of out-of-pocket anticipated expenses, multiplied by the actual risk factor of running into the expenses and multiplied by a coefficient of profitability or costs associated with the policy.

The next step is to provide 85 to the injured party and/or the defendant or their respective counsels or any other party responsible for the transaction the premium to be paid to acquire from a third party the third-party insurance and allowing the injured party and the defendant to enter into the settlement 86 of the personal injury claim and paying as part of the settlement the premium to the third party insurance.

Other steps in the method may include collecting in the database 90 located in the memory of the server is performed using one of a group consisting of collection over time by the third-party insurance entity of data from a plurality of past settlements entered between injured parties and defendants 92, collection of data from a governmental entity having historical data 93, and using a mathematical and actuarial model to generate the data 91. For example, the risk factor determined above (i.e. the chances of incurring the medical expenses for a specific individual) may be found by way of actuarial determination, using existing data already collected and used by the government or an agency or by using compiled data of the system as it performs the work over time.

What is also contemplated is the step of paying to the third party insurance entity the premium 86 or allowing the third-party insurance entity to pay for medical services provided by a medical care facility to the injured party 87 and to include as data in the database the payment of the medical services.

In some cases as shown at FIG. 5, the step of calculating the premium 84 includes a substep of obtaining a validation from a governmental 88 entity that the coverage associated with the premium is sufficient to relieve the Primary Payer of a legal liability under the law. At that moment, the step 94 may include the return of this information to the primary payer.

The method described above may be embodied in multiple different platforms and computer enabling systems using different types of technology. For example, systems may be embodied over the Internet, a LAN Network, a wireless network, a cell network, etc. FIG. 4 shows how a server 1002 of the system 1000 that works by hosting different computer processing units (CPUs) and working using programming language running in memory connected to the CPU to work different applications. The server as shown includes a network connection 1006 and is shown connected to the internet or a wireless system 1001 also connected either to other stations 1005 operated by different actors 1004 or in some cases where the server 1002 and the different stations 1005 merge into a single hardware. With the advance of technology, different tools such as tablets 1012, cell phones 1010 or web-enabled phones 1011 are used 1009 by either other people 1003 connected to a network 1007.

What is shown at FIG. 4 is system 1000 for generating a Primary Payer insurance comprising a database located in the memory of a server 1002, a computer station 1005 connected via a computer network 1001 to the server 1002 for running a software application capable of generating a premium for a Primary Payer insurance entity and a remote user 1003 of the Primary Payer insurance using a tool 1009 to upload to the computer station 1005 at least one injury suffered by an injured party to be covered by the Primary Payer insurance, where the database includes data associated with anticipated future medical cost for each of a plurality of injuries, the remote user 1009 enters in the computer station 1005 information on one injury suffered by the injured party for which future medical costs can be anticipated as part of the database.

The server data relating to the one injury suffered by the injured party is used to calculate by the server a premium to be paid by a Primary Payer for a limit of coverage of the injured party, and where the remote user is given the premium to be paid to acquire from a third party the third-party insurance. In some embodiments, the remote user is one of a group consisting of an injured party of a personal injury claim, an attorney representing an injured party of a personal injury claim, a primary payer, a defendant in a personal injury claim, an attorney for a defendant in a personal injury claim insurance broker and strategic partner.

The database can include third-party insurance data from a plurality of past settlements entered into between injured parties and defendants, the database can include collection of data from a governmental entity having historical data on anticipated future medical cost for each of a plurality of injuries, or the database can include data anticipated future medical cost for each of a plurality of injuries generated using a mathematical and actuarial model to generate the data.

What is described is a new method for promoting the settlement of a claim, the method comprising the creation by a third party of a PMI insurance for covering a risk of future medical costs assumed by a Primary Payer of a settling party, the PMI insurance including an initial fee, a maximum payment amount from the Primary Payer to a secondary payer, and wherein the initial fee of the PMI insurance is to be paid by a first party and transferred to a second party, selling by the third party to a settling party the PMI, settling a claim between the settling party and a plaintiff for a maximum payment amount in future medical expenses, allowing the settling party to pay the initial fee of the PMI insurance to the third party, setting the Primary Payer as the owner of the PMI insurance and the secondary payer as the beneficiary of the PMI, and allowing the secondary payer to make claims on the PMI insurance if at least an initial condition of the PMI insurance is enabled.

It is understood the preceding is merely a detailed description of some examples and embodiments of the present invention and that numerous changes to the disclosed embodiments may be made in accordance with the disclosure made herein without departing from the spirit or scope of the invention. The preceding description, therefore, is not meant to limit the scope of the invention, but to provide sufficient disclosure to one of ordinary skill in the art to practice the invention without undue burden.

What is claimed is:

1. A method for generating a primary payer insurance, the method comprising the steps of:
collecting in a database located in the memory of a server, data associated with anticipated future medical cost for each of a plurality of injuries;
allowing an injured party and a defendant to enter into a negotiation of a settlement of a personal injury claim between the injured party and the defendant, the settlement associated with one injury suffered by the injured party part of the plurality of injuries in the database for which data associated with anticipated future medical costs is available;
collecting from the defendant information on one injury suffered by the injured party for which future medical costs may be anticipated;
calculating using the server data relating to the one injury suffered by the injured party a premium to be paid by the Primary Payer for a limit of coverage of the injured party by a primary payer insurance to cover the anticipated future medical costs of the injured party linked with the one injury of the injured party;
providing to the injured party and the defendant the premium to be paid to acquire from a third party the third-party insurance; and
allowing the injured party and the defendant to enter into the settlement of the personal injury claim and paying as part of the settlement the premium to the third party insurance.

2. The method of claim 1, wherein the step of collecting in the database located in the memory of the server is performed using one of a group consisting of: collection over time by the third-party insurance entity of data from a plurality of past settlements entered into between injured parties and defendants, collection of data from a governmental entity having historical data, and using a mathematical and actuarial model to generate the data.

3. The method of claim 1, further comprising the step of paying to the third-party insurance entity the premium.

4. The method of claim 2, further comprising the steps of allowing the third-party insurance to pay for medical services provided by a medical care facility to the injured party and to include as data in the database the payment of the medical services.

5. The method of claim 1, wherein the step of calculating the premium includes a substep of obtaining a validation from a government entity the coverage associated with the premium is sufficient to relieve the Primary Payer of a legal liability under the law.

6. The method of claim 1, wherein the step of calculating the premium includes a substep of requesting from the Primary Payer the coverage needed and wherein the step of providing to the injured party the premium includes the substep of providing the Primary Payer the level of coverage associated with the premium.

7. The method of claim 1, wherein the settlement of the personal injury claim is reached for a fixed coverage irrespective of the treatment costs, frequencies and/or duration of the treatment or interest of a governmental entity.

8. The method of claim 1, wherein the settlement of the personal injury claim is reached based on a coverage and associated calculated premium collected from a governmental entity.

9. A system for generating a primary payer insurance comprising:
a database located in the memory of a server;
a computer station connected via a computer network to the server for running a software application capable of generating a premium for a primary payer insurance entity; and
a remote user of the primary payer insurance entity using a tool to upload to the computer station at least one injury suffered by an injured party to be covered by the primary payer insurance,
wherein the database includes data associated with anticipated future medical cost for each of a plurality of injuries, wherein the remote user enters in the computer station information on one injury suffered by the injured party for which future medical costs may be anticipated as part of the database, wherein the server data relating to the one injury suffered by the injured party is used to calculate by the server a premium to be paid by a Primary Payer for a limit of coverage of the injured party, and wherein the remote user is given the premium to be paid to acquire from a third-party the third party insurance.

10. The system of claim 9, wherein the remote user is one of a group consisting of an injured party of a personal injury claim, an attorney representing an injured party of a personal injury claim, a primary payer, a defendant in a personal injury claim, an attorney for a defendant in a personal injury claim, and an insurance broker.

11. The system of claim 9, wherein the database includes third-party insurance data from a plurality of past settlements entered between injured parties and defendants.

12. The system of claim 9, wherein the database includes collection of data from a governmental entity having historical data anticipated future medical cost for each of a plurality of injuries.

13. The system of claim 9, wherein the database includes data on anticipated future medical cost for each of a plurality of injuries generated using a mathematical and actuarial model to generate the data.

14. The system of claim 9, wherein the computer network is the internet and the tool is a cell phone app.

15. The system of claim 9, wherein the server and the computer station are on the same computer.

16. The system of claim 9, wherein the database further includes data for each of the plurality of injuries broken down per year of expected life of the beneficiary of the primary payer insurance.
